(19) United States
(12) Patent Application Publication
(10) Pub. No.: US 2005/0286869 A1
(43) Pub. Date: Dec. 29, 2005

(54) Information recording medium, information recording apparatus and method, information reproducing apparatus and method, computer program product, and data structure including control signal

(76) Inventors: Keiji Katata, Saitama (JP); Takeshi Koda, Saitama (JP); Nobuyuki Takakuwa, Saitama (JP)

Correspondence Address: YOUNG & THOMPSON, 745 SOUTH 23RD STREET, 2ND FLOOR, ARLINGTON, VA, 22202, US

(21) Appl. No.: 11/150,251

(22) Filed: Jun. 13, 2005

(30) Foreign Application Priority Data
Jun. 11, 2004 (JP) 2004-174729

(51) Int. Cl. H04N 5/781

(52) U.S. Cl. 386/95; 386/125

(57) ABSTRACT

An information recording medium complies with a predetermined file system, and is provided with: a logical first recording area to record therein a first file which is recorded and reproduced by a first application; and a logical second recording area to record therein a second file which is recorded and reproduced by a second application different from the first application.

### BACKGROUND OF THE INVENTION

1. Field of the Invention

The present invention relates to an information recording medium, such as a DVD, an information recording apparatus and method, such as a DVD recorder, an information reproducing apparatus and method, such as a DVD player, a computer program product which makes a computer function as the information recording apparatus or the information reproducing apparatus, and a data structure including a control signal.

2. Description of the Related Art

Now, personal computers (PCs) are widespread at home in general and are used for various applications. Moreover, household electric appliances including AV equipment, such as a television and a DVD player, are also widespread at home, in general.

On the other hand, in order to integrate the data structures of files recorded on various information recording media, a standard of a Universal Disk Format (UDF) is suggested by Optical Storage Technology Association (OSTA). The UDF is a disc format which is independent of an Operating System (OS). By virtue of the integrated disc format of the UDF, it is possible to perform a recording operation or a reproduction operation of various files with respect to a DVD or the like by using a PC, and it is also possible to perform the recording operation or the reproduction operation various files with respect to the same DVD or the like.

### SUMMARY OF THE INVENTION

However, because an application which is originally operated in the PC and an application which is originally operated in the household electric appliance differ, the use of one recording medium on both the PC and the household electric appliance, for example, may cause various problems. For example, according to a DVD recorder, which is a household electric appliance, various TV programs, movies or the like are recorded as files in a format that complies with the application of the DVD recorder. On the other hand, according to the PC, general files (e.g. a text file and the like) which are used for word processing software or the like are recorded. Namely, the files used for the application of the PC and the files used for the application of the household electric appliance are mixed on one recording medium. In this case, the PC can mainly perform file operations of copy, transfer, delete, change and the like of the file. Thus, there is such a technical problem that the files that comply with the application of the DVD recorder cannot be reproduced because of the file operations. For example, the files that comply with the application of the DVD recorder or the like need to satisfy various restrictions (e.g. a file name, a file recording position, a unit of extent which constitutes the file), which are more strict than those of the files recorded by the PC, due to the standard of the DVD-video or the like. Therefore, if the file operations from the PC are performed without consideration with respect to the files which are recorded with the various restrictions satisfied, it becomes hardly possible to reproduce TV programs, movies or the like by using these files, which is technically a problem.

As described above, there is such a technical problem that if the plurality of files that comply with various applications are mixed and recorded on one DVD, it is impossible to ensure an appropriate reproduction operation, recording operation, etc., only by implementing a DVD application on the PC. Moreover, it is conceivable to avoid such a disadvantage by instructing a user not to perform those types of file operations by the PC; however, it cannot be said that this is an effective solution, from the viewpoint of such a reality of the consumer market that a user friendly PC and household electric appliances are preferred.

It is therefore an object of the present invention to provide an information recording medium on which the recording and reproduction can be performed, preferably, by each of a plurality of applications, an information recording apparatus and method, an information reproducing apparatus and method, a computer program product which makes a computer function as the information recording apparatus and the information reproducing apparatus, and a data structure including a control signal.

(Information Recording Medium)

The above object of the present invention can be achieved by an information recording medium which complies with a predetermined file system (e.g. a UDF described later), provided with: a logical first recording area (e.g. a main partition described later) to record therein a first file which is recorded and reproduced by a first application; and a logical second recording area (e.g. a sub partition described later) to record therein a second file which is recorded and reproduced by a second application different from the first application.

According to the information recording medium of the present invention, the first file is recorded by the first application (e.g. a general-purpose application used for the PC or the like) into the first recording area. On the other hand, the second file is recorded by the second application (e.g. an exclusive application used for the household electric appliance, such as a DVD recorder) into the second recording area which is different from the first recording area (e.g. a recording area that is one portion of the first recording area, as described later). Namely, the information recording medium has different recording areas, depending on the type (or application) of the files used for respective different applications.

Therefore, the first file which is recorded in the first recording area is recorded and reproduced mainly by the first application, so that the recording and the reproduction with respect to the first file by the second application are not performed as a rule. On the other hand, the second file which is recorded in the second recording area is recorded and reproduced mainly by the second application, so that the recording and the reproduction with respect to the second file by the first application are not performed as a rule. Thus, it is possible to prevent or eliminate such a disadvantage that a format of the second file which is recorded in accordance with the standard of the second application, for example, is changed into another format that does not comply with the standard of the second application by the file operations performed by the first application (e.g. a copy operation, a delete operation, a change operation, etc.). In the same manner, it is possible to prevent or eliminate such a disadvantage that a format of the first file which is recorded in accordance with the standard of the first application, for example, is changed into another format that does not comply with the standard of the first application by the file operations performed by the second application (e.g. a copy operation, a delete operation, a change operation, etc.).

As described above, allocating (or providing) logically different recording areas depending on the type of the files to be recorded does not cause a particular problem in the recording operation and the reproduction operation of the files or the like, even if the various files are recorded by the respective different applications with respect to one information recording medium.

Consequently, according to the information recording medium of the present invention, the recording operation and the reproduction operation of the various files can be preferably performed by the respective plurality of different applications.

Incidentally, in the present invention, each of the “first recording area” and the “second recording area” is allocated as a logical recording area with respect to the file system. Namely, there is a single recording area (e.g. a data recording area and a group of data recording areas in a plurality of recording layers if the information recording medium has the plurality of the recording layers, as described later) physically; however, there are a plurality of recording areas logically. This does not cause such a disadvantage that a certain recording area cannot be recognized, as in the case of the division of the physical recording area, which is advantageous.

In addition, by allocating the logically different recording areas, it is possible to provide an additional recording point for each of the first recording area and the second recording area. Therefore, it is possible to record the files, more flexibly.

In one aspect of the information recording medium of the present invention, the second recording area is located in the first recording area.

According to this aspect, it is possible to provide the second recording area in one portion of the first recording area which occupies the whole recording area of the information recording medium.

In another aspect of the information recording medium of the present invention, the second recording area is treated as a used area for the first application.

According to this aspect, even if the first recording area and the second recording area exist on one information recording medium, since the first application regards the second recording area as the used recording area, there is no particular problem in the recording operation and the reproduction operation. Namely, it is possible to prevent such a disadvantage that the first application performs the recording operation of the first file with respect to the second recording area, and the file operations of the second file, or the like.

Incidentally, the first recording area may or may not be located in the second recording area. Moreover, if the first recording area is located in the second recording area, the first recording area is preferably treated as a used area for the second application.

In another aspect of the information recording medium of the present invention, the first application is a general-purpose application used for general recording and reproduction in the predetermined file system, and the second application is an exclusive application used for a particular application in the predetermined file system.

According to this application, it is possible to realize the information recording medium with which both the general-purpose application (e.g. the application used for the PC or the like, and specifically the OS (Operating System) or the like) and the exclusive application (e.g. the application for the special application which is used for the household electric appliance or the like, and specifically a DVD-video application or the like) can be handled.

In another aspect of the information recording medium of the present invention, the first file is recorded only in the first recording area, and the second file is recorded only in the second recording area.

According to this aspect, the second file is not recorded into the first recording area by the first application anymore, and the first file is not recorded into the second recording area by the second application anymore. Namely, it is possible to clearly distinguish the first recording area and the second recording area, depending on the type of the files and the applications or the like. Therefore, it is possible to record and reproduce the files, more preferably, onto or from one information recording medium, by the respective plurality of different applications.

In another aspect of the information recording medium of the present invention, the first file is recorded into the first recording area so as to have a data structure that complies with the predetermined file system, and the second file is recorded into the second recording area so as to have a data structure that complies with the predetermined file system.

According to this aspect, since the data structure of the first recording area is the same as that of the second recording area, it is possible to perform the reading operation (i.e. recognizing operation) of the second file by the first application, for example. On the other hand, it is possible to perform the reading operation (i.e. recognizing operation) of the first file by the second application.

However, since the first file complies with the standard of the first application, the recording and the reproduction of the first file are not actually performed by the second application. Moreover, since the second file complies with the standard of the second application, the recording and the reproduction of the second file are not actually performed by the first application. Thus, even if the first file and the second file have the same data structure, there is no particular problem.

In another aspect of the information recording medium of the present invention, the first file is recorded into the first recording area so as to have a data structure that complies with the predetermined file system, and the second file is recorded into the second recording area so as to have at least one portion of the data structure (e.g. a subset data structure described later) that complies with the predetermined file system.

According to this aspect, if the second file is recorded into the second recording area so as to have at least one portion of the data structure, it is possible to perform the reading operation (i.e. recognizing operation) of the second file by the first application, for example. Incidentally, this “at least one portion of the data structure” preferably has a data structure which is extracted such that the second file can be recognized by the first application, out of the data structure that complies with the predetermined file system.

In another aspect of the information recording medium of the present invention, management information (various information for indicating a thumbnail, a title, or the like) which is used by the second application and which is to manage the second file is further recorded into the second recording area.

According to this aspect, it is possible to manage the second recording area in which many second files can be recorded, preferably and relatively easily, by referring to the management information.

Moreover, the management information may be recorded into the first recording area. Obviously, management information which is used by the first application and which is to manage the first file may be further recorded into the first recording area.

In an aspect of the information recording medium on which the management information is recorded as described above, the information recording medium is provided with at least two second recording areas, the second file is recorded into one second recording area out of the at least two second recording areas, and the management information used by the second application is recorded in another second recording area which is different from the one second recording area.

By virtue of such construction, it is possible to read the management information by accessing another second recording area, without accessing the one second recording area where the second file is recorded. As described above, since there is the second recording area to record therein the management information, as compared to the case where the management information is read from a single second recording area, it is possible to greatly reduce a time required for the reading. As a result, it is possible to manage the second recording areas where many second files can be recorded, preferably and relatively easily.

In another aspect of the information recording medium of the present invention, allocation information for indicating at least one of allocation (e.g. information for indicating at which position of the information recording medium or the first recording area the second recording area is located) and a size (e.g. an areal size or extent) of the second recording area with respect to a whole recording area of the information recording medium is further recorded into the second recording area.

According to this aspect, even if the structure of the second recording area (e.g. positions where the plurality of second files are recorded, etc.) is changed unintentionally, it is possible to restore the second recording area (i.e. to return the second recording area to the original structure) again, by referring to the allocation information including the position where the second recording area is originally located and the size thereof. Obviously, the allocation information may be recorded into the first recording area, and allocation information about the first recording area may be further recorded.

In another aspect of the information recording medium of the present invention, pointer information for indicating a particular address position in the second recording area is further recorded into the first recording area.

According to this aspect, even if the second recording area cannot be accessed via a normal access route, it is possible to directly access the second recording area via another route different from the normal access route (i.e. a preliminary route), by referring to the pointer information. Namely, even if the data for indicating the access route between the first recording area and the second recording area is damaged for some reasons, it is possible to access the second recording area, preferably.

In another aspect of the information recording medium of the present invention, pointer information for indicating a particular address position (e.g. an address position of a file entry ICB (Sub P) described later) in the first recording area is further recorded into the second recording area.

According to this aspect, it is possible to access a particular recording area in the first recording area from the second recording area, by referring to the pointer information. Therefore, even if the second recording area cannot be accessed from the first recording area, it is possible to specify an access route from the accessed second recording area to the first recording area (and moreover, the original access route, which is in the opposite direction, from the first recording area to the second recording area) if the second recording area can be accessed by using the above-described preliminary route.

In another aspect of the information recording medium of the present invention, attribute information for indicating at least one of an attribute of the second file, a transfer rate in recording or reproducing the second file, a minimum size of units which constitute the second file, and a seek rate of the second file is further recorded into the second recording area.

According to this aspect, it is possible to preferably provide or manage the second recording area, by referring to the attribute information. Obviously, the attribute information may be recorded into the first recording area, and attribute information about the first recording area may be further recorded.

In another aspect of the information recording medium of the present invention, application information for specifying the second application is further recorded into the second recording area.

According to this aspect, an information recording apparatus or an information reproducing apparatus can identify the second application by which the second file is recorded or reproduced with respect to the second recording area, relatively easily, by referring to the application information. Therefore, it is possible to avoid such a disadvantage that the second file is recorded or reproduced by a wrong or inappropriate application. Obviously, this application information may be recorded into the first recording area, and application information for specifying the first application may be further recorded.

In another aspect of the information recording medium of the present invention, the second recording area is treated as a read-only recording area for the first application.

According to this aspect, it is possible to avoid such a disadvantage that the second file recorded in the second recording area is reproduced by the first application by errors. Therefore, it is possible to avoid a disadvantage of the false operation of the information reproducing apparatus or the like, which is caused by the erroneous reproduction. Obviously, the first recording area may be treated as a read-only recording area for the second application.

In another aspect of the information recording medium of the present invention, the information recording medium is provided with a plurality of second recording areas.

According to this aspect, it is possible to record the second file by using the plurality of second recording areas. Moreover, it is possible to read and reproduce the desired second file, from the plurality of second recording areas. Therefore, it is possible to use the second recording areas, more efficiently.

In an aspect of the information recording medium having the plurality of second recording areas as described above, each of the plurality of second recording areas has an identification number for identifying the each second recording area.

By virtue of such construction, even if there are the plurality of second recording areas, it is possible to recognize each of them, preferably. Obviously, the information recording medium may be provided with a plurality of first recording areas, and each of the plurality of first recording areas may have an identification number for identifying the each first recording area.

(Information Recording Apparatus)

The above object of the present invention can be also achieved by an information recording apparatus for performing a recording operation with respect to the above-described information recording medium of the present invention (including its various aspects), the information recording apparatus provided with: a first recording device for recording the first file into the first recording area in accordance with the first application; and a second recording device for recording the second file into the second recording area in accordance with the second application.

According to the information recording apparatus of the present invention, it is possible to record the first file into the first recording area, by the operation of the first recording device operated in accordance with the first application. Moreover, it is possible to record the second file into the second recording area, by the operation of the second recording device operated in accordance with the second application. Therefore, it is possible to record the first file and the second file, preferably, onto the information recording medium of the present invention. By this, it is possible to receive the same benefits as those owned by the information recording medium of the present invention.

Incidentally, in response to various aspects in the above-described information recording medium of the present invention, the information recording apparatus of the present invention can also adopt various aspects.

Moreover, the present invention includes not only an information recording apparatus which can record both the first file and the second file, but also an information recording apparatus which records either one of them. Namely, the information recording apparatus may be an information recording apparatus provided with: a first recording device for recording the first file into the first recording area; and a controlling device for controlling the first recording device to record the first file in accordance with the first application. Alternatively, the information recording apparatus may be an information recording apparatus provided with: a second recording device for recording the second file into the second recording area; and a controlling device for controlling the second recording device to record the second file in accordance with the second application.

In one aspect of the information recording apparatus of the present invention, it is further provided with a generating device for generating the second recording area by setting at least one portion of the first recording area to be a recording area to record therein the second file.

According to this aspect, by the operation of the generating device, it is possible to generate a new second recording area if needed, relatively easily.

In another aspect of the information recording apparatus of the present invention, allocation information for indicating at least one of allocation and a size of the second recording area with respect to a whole recording area of the information recording medium is recorded into the first recording area, and the information recording apparatus further comprises a reconstructing device for reconstructing the second recording area, on the basis of the allocation information, if the second recording area is damaged.

According to this aspect, even if the structure of the second recording area (e.g. positions where the plurality of second files are recorded, etc.) is changed unintentionally, it is possible to restore the second recording area (i.e. return the second recording area to the original structure) again, by the operation of the reconstructing device which refers to the allocation information.

(Information Recording Method)

The above object of the present invention can be also achieved by an information recording method of performing a recording operation with respect to the above-described information recording medium of the present invention (including its various aspects), the information recording method provided with: a first recording process of recording the first file into the first recording area in accordance with the first application; and a second recording process of recording the second file into the second recording area in accordance with the second application.

According to the information recording method of the present invention, it is possible to receive the same various benefits as those of the information recording apparatus of the present invention described above.

Incidentally, in response to various aspects in the above-described information recording apparatus of the present invention, the information recording method of the present invention can also adopt various aspects.

(Information Reproducing Apparatus)

The above object of the present invention can be also achieved by an information reproducing apparatus for performing a reproduction operation with respect to the above-described information recording medium of the present invention (including its various aspects), the information reproducing apparatus provided with: a first reproducing device for reading and reproducing the first file recorded in the first recording area in accordance with the first application; and a second reproducing device for reading and reproducing the second file recorded in the second recording area in accordance with the second application.

According to the information reproducing apparatus of the present invention, it is possible to read and reproduce the first file recorded in the first recording area, by the operation of the first reproducing device operated in accordance with the first application. Moreover, it is possible to read and reproduce the second file recorded in the second recording area, by the operation of the second reproducing device operated in accordance with the second application. Therefore, it is possible to reproduce the first file and the second file read from the information recording medium of the present invention, preferably. By this, it is possible to receive the same benefits as those owned by the information recording medium of the present invention.

Incidentally, in response to various aspects in the above-described information recording medium of the present invention, the information reproducing apparatus of the present invention can also adopt various aspects.

Moreover, the present invention includes not only an information reproducing apparatus which can reproduce both the first file and the second file, but also an information recording apparatus which reproduces either one of them. Namely, the information reproducing apparatus may be an information reproducing apparatus provided with: a first reproducing device for reading and reproducing the first file recorded in the first recording area; and a controlling device for controlling the first reproducing device to reproduce the first file in accordance with the first application. Alternatively, the information reproducing apparatus may be an information reproducing apparatus provided with: a second reproducing device for reading and reproducing the second file recorded in the second recording area; and a controlling device for controlling the second reproducing device to reproduce the second file in accordance with the second application.

In one aspect of the information reproducing apparatus of the present invention, the first file is recorded in the first recording area so as to have a data structure that complies with the predetermined file system, the second file is recorded in the second recording area so as to have a data structure that complies with the predetermined file system, and the first reproducing device reads the second file recorded in the second recording area.

According to this aspect, since the data structure of the first recording area is the same as that of the second recording area, the first reproducing device can read not only the first file but also the second file. Therefore, by the operation of the first reproducing device, it is possible to recognize or manage the various files recorded on the whole information recording medium, relatively easily.

(Information Reproducing Method)

The above object of the present invention can be also achieved by an information reproducing method of performing a reproduction operation with respect to the above-described information recording medium of the present invention (including its various aspects), the information reproducing method provided with: a first reproducing process of reading and reproducing the first file recorded in the first recording area in accordance with the first application; and a second reproducing process of reading and reproducing the second file recorded in the second recording area in accordance with the second application.

According to the information reproducing method of the present invention, it is possible to receive the same various benefits as those of the information reproducing apparatus of the present invention described above.

Incidentally, in response to various aspects in the above-described information reproducing apparatus of the present invention, the information reproducing method of the present invention can also adopt various aspects.

(Computer Program Product)

The above object of the present invention can be also achieved by a first computer program product in a computer-readable medium for tangibly embodying a program of instructions executable by a computer to make the computer function as at least one portion of the above-described information recording apparatus (including its various aspects). Moreover, the above object of the present invention can be also achieved by a second computer program product in a computer-readable medium for tangibly embodying a program of instructions executable by a computer to make the computer function as at least one portion of the above-described information reproducing apparatus (including its various aspects).

According to the first or second computer program product of the present invention, the above-described information recording apparatus or information reproducing apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the above-described information recording apparatus or information reproducing apparatus.

Incidentally, in response to various aspects of the above-described information recording apparatus or information reproducing apparatus of the present invention, the first or second computer program product of the present invention can also adopt various aspects.

(Data Structure)

The above object of the present invention can be achieved by a data structure including a control signal which complies with a predetermined file system, provided with: a logical first recording area to record therein a first file which is recorded and reproduced by a first application; and a logical second recording area to record therein a second file which is recorded and reproduced by a second application different from the first application.

According to the data structure including a control signal of the present invention, it is possible to receive the same benefits as those owned by the information recording medium of the present invention.

Incidentally, in response to various aspects in the above-described information recording medium of the present invention, the data structure of the present invention can also adopt various aspects.

The nature, utility, and further features of this invention will be more clearly apparent from the following detailed description with reference to preferred embodiment of the invention when read in conjunction with the accompanying drawings briefly described below.

As explained above, according to the information recording medium of the present invention, it is provided with the first recording area and the second recording area. Therefore, it is possible to record, reproduce, etc., the first file and the second file, preferably, by the respective plurality of applications.

As explained above, according to the information recording apparatus of the present invention, it is provided with the first recording apparatus and the second recording apparatus. According to the information recording method of the present invention, it is provided with the first recording process and the second recording process. Therefore, it is possible to record the first file and the second file, preferably, onto the information recording medium of the present invention. Moreover, according to the information reproducing apparatus of the present invention, it is provided with the first reproducing apparatus and the second reproducing apparatus. According to the information reproducing method of the present invention, it is provided with the first reproducing process and the second reproducing process. Therefore, it is possible to reproduce the first file and the second file recorded on the information recording medium of the present invention, preferably.

### BRIEF DESCRIPTION OF THE DRAWINGS

FIG. 1 is a diagram showing an optical disc in an embodiment of an information recording medium of the present invention, the upper part being a schematic plan view of the optical disc having a plurality of areas, the corresponding bottom part being a schematic diagram of the structures of the areas in the radial direction;

FIG. 2A and FIG. 2B are explanatory diagrams conceptually showing logical recording areas on the information recording medium in the embodiment;

FIG. 3 is a diagram showing a logical data structure which defines the information recording medium having the logical recording areas shown in FIG. 2, in more detail;

FIG. 4 is a diagram showing the logical data structure which defines the information recording medium having the logical recording areas shown in FIG. 2 and particularly which is associated with a sub partition, in more detail;

FIG. 5A and FIG. 5B are explanatory diagrams conceptually showing aspects of restoration (reconstruction) of the sub partition;

FIG. 6 is an explanatory diagram conceptually showing an information recording medium in a modified example;

FIG. 7 is a block diagram showing an information recording/reproducing apparatus in the embodiment of an information recording apparatus and an information reproducing apparatus of the present invention;

FIG. 8 is one explanatory diagram conceptually showing a file recorded in the sub partition during a recording operation of the information recording/reproducing apparatus in the embodiment; and

FIG. 9 is another explanatory diagram conceptually showing the file recorded in the sub partition during the recording operation of the information recording/reproducing apparatus in the embodiment.

### DETAILED DESCRIPTION OF THE PREFERRED EMBODIMENTS

Embodiments of the present invention will be hereinafter explained with reference to the drawings.

(Information Recording Medium)

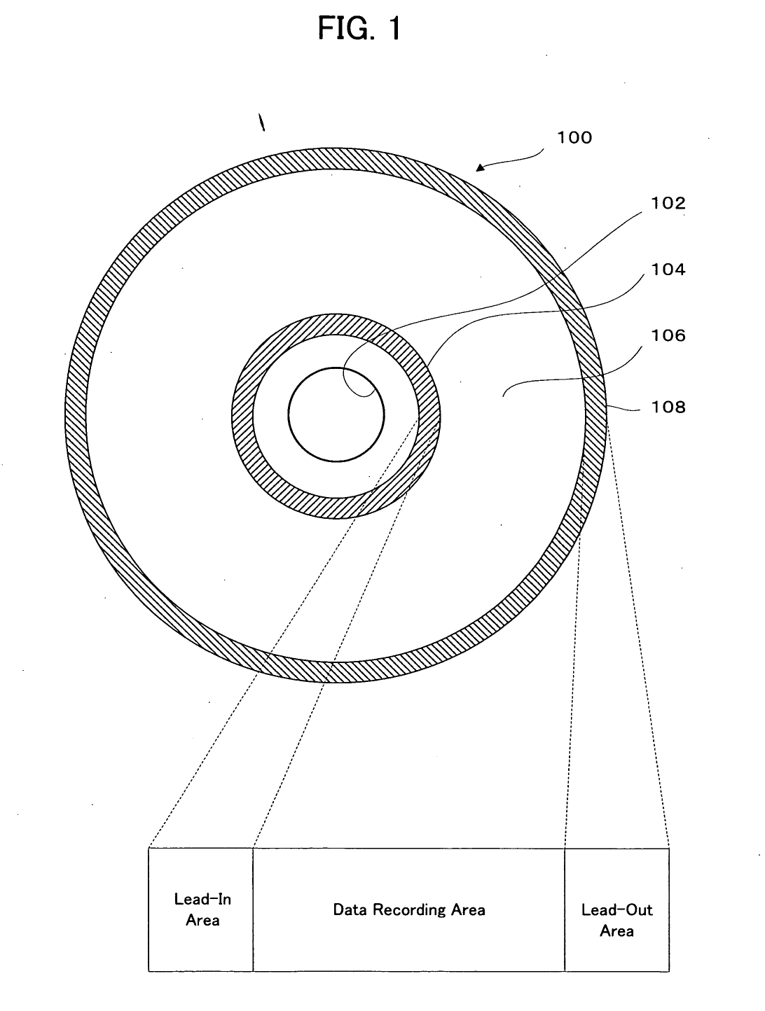

At first, an embodiment of an information recording medium of the present invention will be explained with reference to FIG. 1 to FIG. 6.

(1) Basic Structure

At first, the basic structure of the information recording medium in the embodiment of the present invention will be explained, with reference to FIG. 1. In the embodiment, the explanation is given by using an optical disc as the information recording medium. FIG. 1 shows the structure of the optical disc having a plurality of areas in a schematic plan view on the upper part, and shows the structures of the areas in the radial direction in a schematic diagram on the corresponding bottom part.

As shown in FIG. 1, information may be recorded on an optical disc 100 in advance by embossed pits or the like, for example. Alternatively, the information may be recorded in various recording methods, such as a magneto optical method and a phase transition method, in which it is possible to record (write) the information a plurality of times or only once. The optical disc 100 has a recording surface on the disc main body, which is about 12 cm in diameter, as is the DVD. On the recording surface, the optical disc 100 is provided with: a lead-in area 104; a data recording area 106; and a lead-out area 108, with a center hole 102 as the center, in the direction from the inner circumference to the outer circumference. In each area, groove tracks and land tracks are alternately placed, spirally or coaxially, with the center hole 102 as the center, for example. These groove tracks may be wobbled, and pre-pits may be formed on either or both of the groove tracks and the land tracks. Incidentally, the present invention is not specially limited to the optical disc having these three areas. For example, even if there is no lead-in area 104 or lead-out area 108, a file structure described later can be constructed. Moreover, the lead-in area 104 and the lead-out area 108 may be further segmentalized.

(2) Data Structure

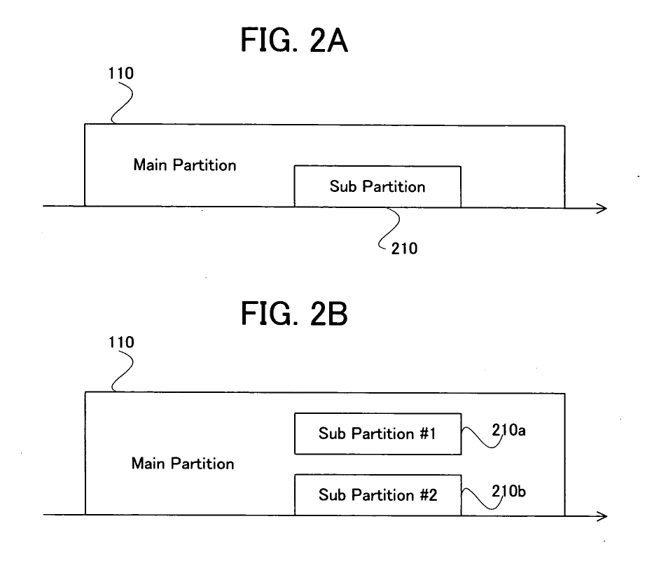

Next, with reference to FIG. 2A and FIG. 2B, the specific data structure of the information recording medium in the embodiment will be explained. FIG. 2A and FIG. 2B conceptually show logical recording areas on the optical disc 100 in the embodiment.

As shown in FIG. 2A, the optical disc 100 is logically provided with a main partition 110, which corresponds to one specific example of the “first recording area” of the present invention, and a sub partition 210, which corresponds to one specific example of the “second recording area” of the present invention. The main partition and the sub partition are the logical recording areas, and do not necessarily correspond to the above-described physical recording area, such as the lead-in area 104, the data recording area 106, and the lead-out area 108. Namely, even if the recording area is physically divided into plural as in the optical disc having a plurality of recording layers, the logical recording areas are not directly related to the physically-divided recording areas. As described later, each of the logical recording areas is provided in a logically-divided aspect depending on the application. Namely, this is greatly different from the division of the physical recording area, such as the so-called partition division of a hard disk of the PC and partition division for operating a plurality of operating systems (OS) on one hard disk.

The main partition 110 is a logical recording area to record therein a file (or information or data) used by a general-purpose application (e.g. OS) which corresponds to one specific example of the “first application” of the present invention and which is used by the personal computer or the like. The file recorded in the main partition 110 corresponds to one specific example of the “first file” of the present invention, and is recorded, reproduced, or executed by the general-purpose application. In other words, only the file which is recorded, reproduced, or executed by the general-purpose application is selectively recorded in the main partition 110.

The sub partition 210 is a logical recording area to record therein a file (or information or data) for the recording, reproduction, or execution performed by an exclusive application (e.g. a DVD-video application), which corresponds to one specific example of the “second application” of the present invention and which is used by the household electric appliances including DVD recorder or the like for the consumer. Particularly, one portion of the recording area of the main partition 110 is allocated as the sub partition 210. For the general-purpose application, the sub partition 210 is recognized as a recorded and allocated area which is already used. The file recorded in the sub partition 210 corresponds to one specific example of the “second file” of the present invention, and is recorded, reproduced, or executed by the exclusive application. In other words, only the file which is recorded, reproduced, or executed by the exclusive application is selectively recorded in the sub partition 210.

As shown in FIG. 2B, a plurality of sub partitions (#1) 210a and (#2) 210b may be provided. With respect to each of the sub partitions (#1) 210a and (#2) 210b, the file may be recorded, etc., by the same application (e.g. the above-described exclusive application). Alternatively, the file may be recorded, etc., by one application (e.g. one exclusive application) with respect to the sub partition (#1) 210a, and the file may be recorded, etc., by another application (e.g. another exclusive application) with respect to the sub partition (#2) 210b. Namely, the file may be recorded, etc., to the plurality of sub partitions by a plurality of different applications respectively.

If the plurality of sub partitions 210 are provided as described above, it is preferable to append an identification number peculiar (or which can be uniquely identified) to each of the sub partitions 210. For example, as shown in FIG. 2B, it is preferable to append an identification number of #1, #2, and so on. This identification number is preferably recorded in a File Set Descriptor (FSD) 120 described later.

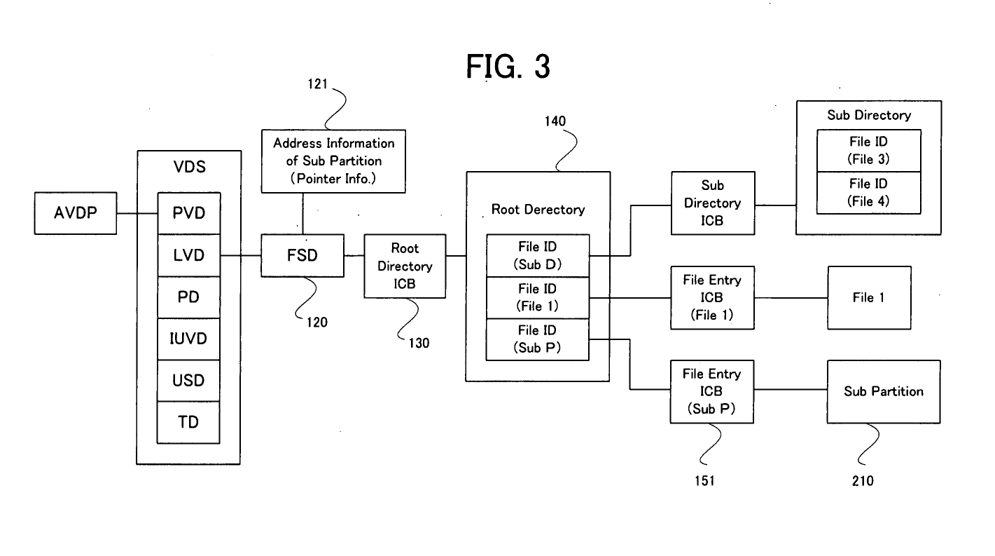

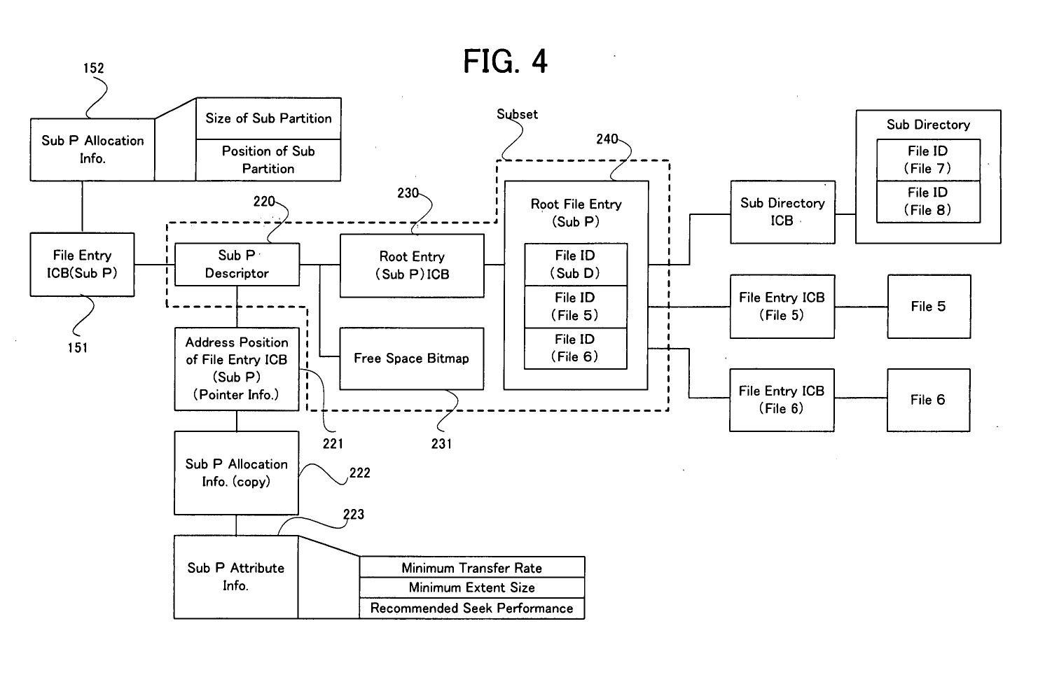

A more specific data structure, for the realization of the optical disc which logically has two partitions corresponding to the two different applications, will be explained with reference to FIG. 3 and FIG. 4. FIG. 3 shows a logical data structure which defines the optical disc having the logical recording areas shown in FIG. 2. FIG. 4 shows the logical data structure which defines the optical disc having the logical recording areas shown in FIG. 2 and particularly which is associated with the sub partition.

Incidentally, in the explanation below, the optical disc 100 has a data structure that complies with the standard of a UDF (Universal Disk Format) as a file system. Therefore, each file shown in the explanation below is recorded in a format that complies with the UDF. The general explanation about the standard of the UDF will be omitted. For the explanation of the standard, a UDF Specification (Revision 2.50) issued by Optical Storage Technology Association (OSTA) shall be referred to. It is obvious that even in a data structure that complies with another standard, it is possible to adopt a structure having two or more partitions, as explained in the embodiment.

As shown in FIG. 3, for the top (or the highest point) of the logical data structure of the optical disc 100, an Anchor Volume Description Pointer (AVDP) is located. The AVDP is pointer information for pointing out an address position (or logical address) where a Volume Description Sequence (VDS) is actually recorded. For example, the VDS is recorded in a recording area with a physical address of “FFh”.

In the VDS, there are recorded various information for indicating all the disc volume spaces of the optical disc 100. As the various information, for example, a Primary Volume Descriptor (PVD), a Logical Volume Descriptor (LVD), a Partition Descriptor (PD), an Implementation Use Volume Descriptor (IUVD), an Unallocated Space Descriptor (USD), a Terminating Descriptor (TD), and the like are listed, as one specific example.

Here, particularly, the LVD indicates an address position where the File Set Descriptor (FSD) 120 is actually recorded. The FSD 120 is provided for each of the logical disc volume spaces of the optical disc 100, one by one. The FSD 120 indicates address information where a root directory ICB 130 for indicating the actual file structure on the optical disc 100 (which is specifically a root directory 140) is actually recorded.

In the root directory 140, a file identifier (file ID) for identifying each of the actual files is recorded. For example, in the data structure shown in FIG. 3, the root directory 140 is provided with: a file ID (Sub D) about a sub directory; a file ID (File 1) about a file 1; and a file ID (Sub P) about a sub partition 210. The file ID (Sub D) indicates an address position where a sub directory ICB is actually recorded. The file ID (File 1) indicates an address position where a file entry ICB (File 1) is actually recorded. The file ID (Sub P) indicates an address position where a file entry ICB (Sub P) 151 is actually recorded.

The sub directory ICB indicates an address position where the entity of the sub directory is actually recorded. The file entry ICB (File 1) indicates an address position where the entity of the file 1 is actually recorded. The file entry ICB (Sub P) 151 indicates an address position where the entity of the sub partition 210 is actually recorded (and specifically an address position where a sub partition descriptor 220 as described later is actually recorded).

Next, the internal data structure of the sub partition will be explained. As shown in FIG. 4, the sub partition descriptor 220 indicates an address position where a root file entry (Sub P) ICB 230 is recorded. The data structure of elements following the root file entry (Sub P) ICB 230 is the substantially same as the data structure of elements following the root directory ICB 130 shown in FIG. 3.

As described above, both the main partition 110 and the sub partition 210 have the tree-shaped data structure that complies with the same standard (or the same file system structure). Therefore, the provision of the sub partition 210 in the main partition 110 does not cause any particular problem when the files recorded on the optical disc 100 (i.e. the main partition 110 and the sub partition 210) are accessed by the general-purpose application.

The file executed, etc., by the exclusive application is recorded in the sub partition 210, and the file executed, etc., by the general-purpose application are recorded in the main partition 110. Therefore, the execution, etc., and various file operations (e.g. copy, transfer, delete, change, etc., of the file) by the exclusive application are not performed with respect to the file recorded in the main partition 110. In the same manner, the execution, etc., and various file operations by the general-purpose application are not performed with respect to the file recorded in the sub partition 210. Therefore, even if the files are recorded, etc., by the respective different applications with respect to one optical disc 100, since the recording area is logically distinguished for each application, there is no influence by the difference of the standard of each application. Namely, the file used by the application is read from the corresponding recording area, so that there is no particular problem in the various operations of the applications or the like.

A more specific example is used for the explanation below. For example, in the existing DVD-video standard (i.e. one specific example of the standard about the exclusive application), the file name determines which file is executed in what way. On the other hand, in the file for the PC (e.g. a text file or the like used by word processing software), it is possible to set, change, etc., the file name, substantially arbitrarily. Even in this case, according to the optical disc 100 provided with the main partition 110 and the sub partition 210 as in the embodiment, even if the file operations or the like are performed by the general-purpose application with respect to the file for the PC, the various file operations or the like are not performed with respect to the file for the DVD-video. Therefore, it is possible to preferably avoid such a disadvantage that the file operations of the general-purpose application, which is normally performed by a user's operation, is performed with respect to the file for the DVD-video and thus the file cannot be executed.

In addition, in some cases, there are different restrictions between the general-purpose application and the exclusive application, such as the minimum extent unit of the file which is recorded, and the interval of the files if the plurality of files are recorded. Even if the two applications have mutually different restrictions, according to the optical disc 100 in the embodiment, each of the files is recorded by respective one of the applications into the corresponding recording area. Thus, it is possible to avoid the above-described disadvantage, preferably. Namely, by the operation of one application, it is possible to avoid such a disadvantage that the file about the other application does not satisfy the restriction which is to be satisfied in a normal situation.

In addition, the sub partition 210 has the same general-purpose data structure (specifically, the data structure that complies with the UDF) as that of the main partition 110. Thus, the sub partition 210 can adopt the same structure even in another file system other than the UDF, for example. Namely, the structure of the sub partition 210 is a portable structure.

Moreover, various elements (i.e. the above-described file set descriptor 220 or the like) which define the data structure of the sub partition 210 and the entity of the file recorded in the sub partition are recorded in the same sub partition 210. Thus, it is possible to reduce a seek time for the exclusive application accessing the sub partition 210.

At this time, the sub partition 210 has the same data structure as that of the main partition 110, so that it is possible to read the file even by the general-purpose application. Namely, it is possible to view (or recognize) what kind of file is recorded. On the other hand, for example, the file recorded in the sub partition 210 complies with the standard of the exclusive application, so that it is impossible to record, reproduce, and execute the file by the general-purpose application. In addition, as described above, for the viewpoint of preventing the change, etc., of the file name, for example, it is preferable that the sub partition 210 is treated as a read-only recording area for the general-purpose application.

Incidentally, the sub partition 210 does not necessarily adopt the same data structure as that of the main partition 110. For example, the sub partition 210 may have a subset data structure, enclosed with a dotted line in FIG. 4. Here, as the subset data structure, the sub partition descriptor 220, the root file entry (Sub P) ICB 230, and the root file entry (Sub P) 240 are listed as one specific example. The sub partition 210 minimally having such a subset data structure can receive the above-described various benefits.

Consequently, according to the optical disc 100 in the embodiment, it is possible to preferably record and reproduce the files with respect to one information recording medium, by the respective plurality of different applications.

Here, the data structure of the information recording medium in the embodiment will be further explained in detail.

Again in FIG. 3, the FSD 120 has pointer information 121 for indicating the address position of the sub partition 210. Specifically, the FSD 120 may have pointer information for indicating the address position of the sub partition descriptor 220, for example. By this, even if the data structure between the FSD 120 and the sub partition descriptor 220 is damaged (or cannot recognized anymore), it is possible to access the sub partition 210 without depending on the damaged data structure, by referring to the pointer information 121. For example, this is effective in the case that the file ID (Sub P) of the root directory 140 is damaged, etc., accidentally, by a user's operation (e.g. an operation of transferring the file) using the general-purpose application. Moreover, even an exclusive application which cannot actually recognize the structure of the UDF itself (e.g. an exclusive application having bugs) can directly access the sub partition 210 and execute the various files, by referring to the pointer information 121 which directly indicates the sub partition 210.

Moreover, as shown in FIG. 4, the sub partition descriptor 220 may have pointer information 221 for indicating the address position of the file entry ICB (Sub P) 151. By this, if the data structure between the FSD 120 and the sub partition descriptor 220 is damaged and the sub partition 210 cannot be accessed from the FSD 120 side (from the so-called upper stream side), it is possible to recognize the data structure between the FSD 120 and the sub partition descriptor 220 from the lower stream side by referring to the pointer information 221. Namely, by referring to the pointer information 221, it is possible to obtain the address position of the file entry ICB (Sub P) 151 from the sub partition descriptor 220 side. If the same operation is performed with respect to the file entry ICB (Sup P) or information which can be obtained subsequently, it is possible to access the FSD 120 in the end. Thus, it is preferable that each element of the data structure shown in FIG. 3 and FIG. 4 has the address position of the element located on the upper stream side, as the pointer information.

Moreover, as shown in FIG. 4, the file entry ICB (Sub P) 151 may have sub partition allocation information 152. The sub partition allocation information 152 includes information for indicating the size of the sub partition 210 and information for indicating the position of the sub partition 210.

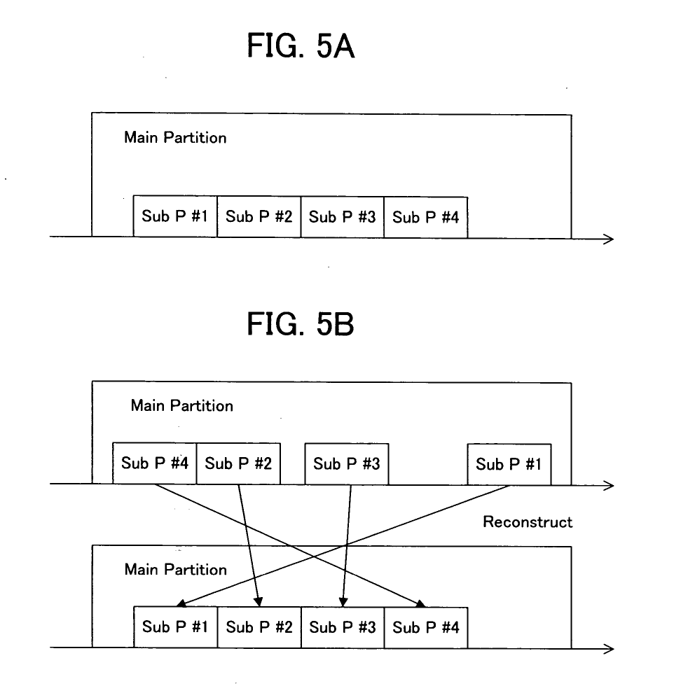

Since such allocation information 152 is provided, even if the location, structure or the like of the sub partition 210 are changed due to the user's file operations using the general-purpose application, it is possible to return them to the original and correct state (i.e. restore them), relatively easily. Aspects of this restoration will be explained in more detail with reference to FIG. 5A and FIG. 5B. FIG. 5A and FIG. 5B show the aspects of restoration (reconstruction) of the sub partition.

For example, as shown in FIG. 5A, it is assumed that the sub partitions #1, #2, #3, and #4 are originally recorded in this order, sequentially. It is also assumed that at the time of reproduction, the sub partitions are individually and sequentially reproduced in this order. Here, if the location of each sub partition is changed, as shown on the upper part of FIG. 5B, that causes a big gap between the sub partitions #1 and #2, for example. Thus, there is such a possibility that the file cannot be reproduced preferably, due to the increase in a jump time or the like (i.e. the seek time or the like) of the optical pickup, as described later. However, by referring to the allocation information, the original size and the location or the like of each sub partition are found out. Thus, it is possible to return them from the state shown on the upper part of FIG. 5B to the state shown on the lower part of FIG. 5B. Therefore, the fact that the allocation information is recorded ensures the preferable reproduction and execution of the file recorded in the sub partition 210.

Moreover, a copy of the sub partition allocation information 152 (sub partition allocation information (copy) 222) may be recorded in the sub partition descriptor 220. Namely, the sub partition allocation information (copy) 222 is recorded in the sub partition 210 where the user's file operations or the like are not performed, except the main partition 110 where the user's file operations are performed easily. Thus, there is little chance that the sub partition allocation information (copy) 222 is damaged due to the user's file operations or the like. By this, even if the sub partition allocation information 152 in the main partition 110 cannot be recognized due to the user's file operations or the like, it is possible to receive the above-described benefits by referring to the sub partition allocation information (copy) 222 in the sub partition 210.

Moreover, if the plurality of sub partitions 210 are provided, as shown in FIG. 2, it is preferable that the sub partition allocation information 152 and the sub partition allocation information (copy) 222 for indicating the above-described size and position are recorded for each of the sub partitions.

Moreover, as shown in FIG. 4, the sub partition descriptor 220 may have sub partition attribute information 223 for indicating the attribute of the sub partition 210. The attribute information 223 includes a minimum transfer rate, a minimum extent size (i.e. a minimum recording unit size), a recommended seek performance or rate, and the like.

The minimum transfer rate is information for indicating the minimum transfer rate in recording or reproducing the file. It may have both the minimum transfer rate at the time of recording and the minimum transfer rate at the time of reproduction. Alternatively, it may have the minimum transfer rate which is common at the time of recording and at the time of reproduction.

The minimum extent size is information for indicating the minimum size of units which constitute the file. For example, in the case of the file about the DVD-video, it may be the size of a Video Object (VOB), or may be the size of a Group Of Picture (GOP) of Moving Picture Experts Group (MPEG). Alternatively, another predetermined value may be regarded as the minimum extent size.

The recommended seek performance or rate is information for indicating a recommended value of the seek performance or rate of the file.

By referring to the sub partition attribute information 223, it is possible to record the file, more preferably, into the sub partition 210, by the exclusive application. Alternatively, it is possible to reproduce and execute the file recorded in the sub partition 210. Moreover, the general-purpose application can perform an operation of allocating the sub partition 210 or similar operations in accordance with the file recorded by the exclusive application.

Moreover, as shown in FIG. 4, a free space bit map 231 for the sub partition 210 may be recorded in the sub partition 210. The free space bitmap 231 is information for managing the recording area in the sub partition 210. For example, the free space bitmap 231 includes flag information for indicating whether each of a plurality of sub recording areas is recorded or unrecorded, wherein the recording area of the sub partition 210 is divided into the plurality of sub recording areas. By referring to the free space bitmap 231, it is possible to recognize the outline of the recording status of the file in the sub partition 210, relatively easily and quickly. Thus, it is possible to further reduce a time required for the execution, etc., of the file recorded in the sub partition 210 by the exclusive application.

Moreover, a domain suffix for indicating the type of the exclusive application or the like may be recorded in the sub partition 210. The domain suffix corresponds to one specific example of the “application information” of the present invention. Incidentally, the domain suffix may be recorded in the FSD 120.

Moreover, management information for managing the various files recorded in the sub partition 210 may be recorded in the sub partition 210. For example, the management information may include information for indicating the title and thumbnail of a TV program or a movie shown by each file recorded in the sub partition 210. By referring to the management information, the management of each file recorded in the sub partition 210 becomes relatively easy. Moreover, it is possible to perform the reproduction and execution operation of the file, relatively quickly.

Furthermore, backup information (or mirror information) for indicating the data structure of the sub partition 210 may be recorded. By this, it is possible to reconstruct the sub partition 210, relatively easily, by using the backup information.

(3) Modified Example

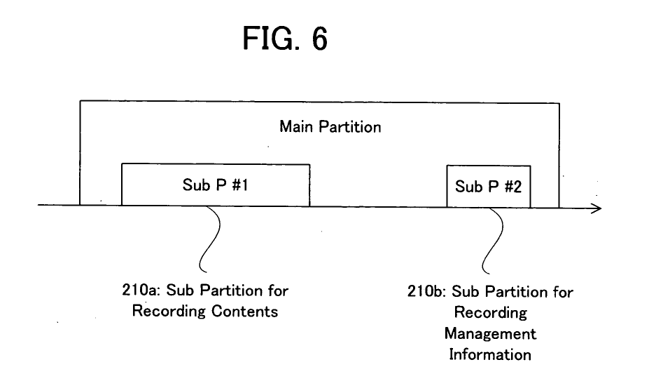

Next, with reference to FIG. 6, a modified example of the information recording medium in the embodiment will be explained. FIG. 6 conceptually shows the information recording medium in the modified example.

As shown in FIG. 6, one sub partition (#1) 210a may be regarded as a sub partition for recording a file about contents information including a TV program or a movie or the like. Another sub partition (#2) 210b may be regarded as a sub partition for recording the above-described management information. It is enough if the other sub partition (#2) 210b has a size large enough to record the management information therein. Generally, the size of the other sub partition (#2) 210b is smaller than that of the one sub partition (#1) 210a.

By this, it is possible to obtain the management information by searching the relatively small recording area. Thus, it is possible to reduce the seek time required for the acquisition of the management information. Moreover, since one sub partition 210 is allocated as the recording area for this management information, it is possible to reserve the continuous 64 MB recording area for the recording of the management information. Therefore, the management information is no longer segmentalized and recorded in the small recording area, which results in the easier management of the sub partition 210.

(Information Recording/Reproducing Apparatus)

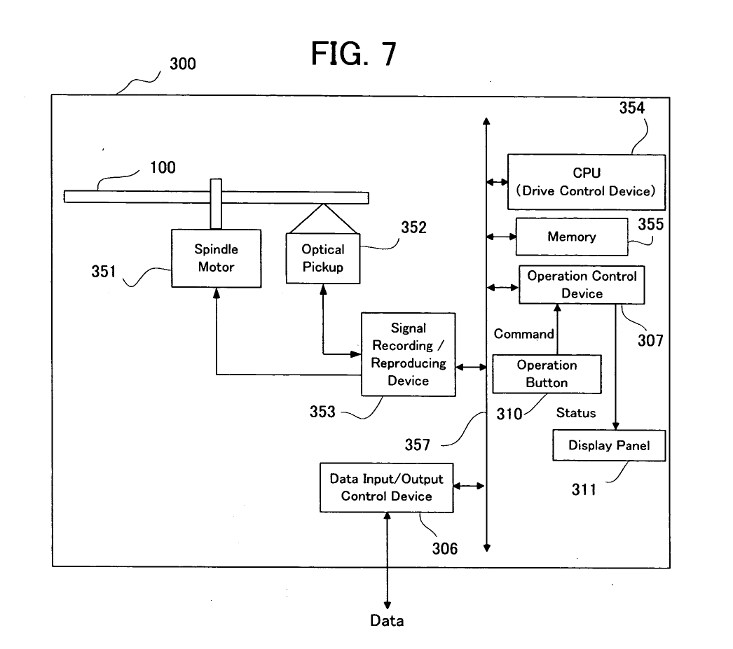

Next, with reference to FIG. 7 to FIG. 9, the information recording/reproducing apparatus in the embodiment of the information recording apparatus and the information reproducing apparatus of the present invention will be explained.

(1) Basic Structure

At first, the structure of an information recording/reproducing apparatus 300 which is the embodiment of the information recording apparatus and the information reproducing apparatus of the present invention will be explained with reference to FIG. 7. FIG. 7 shows the information recording/reproducing apparatus 300 in the embodiment of the present invention. The information recording/reproducing apparatus 300 has a function of recording information onto the optical disc 100 and a function of reproducing the information recorded on the optical disc 100.

With reference to FIG. 7, the inner structure of the information recording/reproducing apparatus 300 will be explained. The information recording/reproducing apparatus 300 records information onto the optical disc 100 and reproduces the information recorded on the optical disc 100, under the control of a processor 354.

The information recording/reproducing apparatus 300 is provided with: the optical disc 100; a spindle motor 351; an optical pickup 352; a signal recording/reproducing device 353; the CPU (drive control device) 354; a memory 355; a data input/output control device 306; an operation control device 307; an operation button 310; a display panel 311; and a bus 357.

The spindle motor 351 is intended to rotate and stop the optical disc 100, and operates in accessing the optical disc 100. More specifically, the spindle motor 351 is constructed to rotate and stop the optical disc 100 at a predetermined speed while receiving spindle servo by a not-illustrated servo unit or the like.

The optical pickup 352 performs the recording/reproducing with respect to the optical disc 100, and has a laser apparatus and a lens. More specifically, the optical pickup 352 irradiates the optical disc 100 with a laser beam, such as laser light, as reading light with a first power at the time of reproduction, and as writing light with a second power at the time of recording, with it modulated.

The signal recording/reproducing device 353 performs the recording/reproducing with respect to the optical disc 100 by controlling the spindle motor 351 and the optical pickup 352.

The memory 355 is used in the all the data processing on the information recording/reproducing apparatus 300, including a buffer area for the record/reproduction data, an area used as an intermediate buffer when data is converted into the data that can be used on the signal recording/reproducing device 353, and the like. Moreover, the memory 355 is provided with: a Read Only Memory (ROM) area into which a program for performing an operation as a recording device is stored; a Random Access Memory (RAM) area which is used as buffer for the compression/decompression of video data and is used as temporarily storage area for storing a parameter required for the program operation; and the like.

The CPU (drive control device) 354 is connected to the signal recording/reproducing device 353 and the memory 355 via the bus 357, and controls the entire information recording/reproducing apparatus 300 by giving an instructions to each control device. In general, software for operating the CPU 354 is stored in the memory 355.

The data input/output control device 306 controls the data input/output from the outside with respect to the information recording/reproducing apparatus 300, and stores the data into or extracts the data from the data buffer on the memory 355. If the data input/output of a video signal is performed, the data received from the outside is compressed (or encoded) into a MPEG format, and then outputted to the memory 355, at the time of data input. At the time of data output, the data in the MPEG format received from the memory 355 is decompressed (or decoded), and then outputted to the outside.

The operation control device 307 performs the reception of the operation instruction and display with respect to the information recording/reproducing apparatus 300. The operation control device 307 sends the instruction of recording or reproducing by using the operation bottom 310, to the CPU 354. Then, the operation control device 307 outputs the operational condition of the information recording/reproducing apparatus 300, such as recording condition and reproduction condition, to the display panel 311, such as a fluorescent tube.

As described above, one example of the information recording/reproducing apparatus 300 is a recording device for recording/reproducing a video as household equipment. The recording device records a video signal from a broadcast receiving tuner or from an external connection terminal onto the optical disc 100, and outputs the video signal reproduced from the optical disc 100 to an external display device, such as a television. The operation as the recording device is performed by executing the program, which is stored in the memory 355, on the CPU 354.

Incidentally, the recording operation, etc., by the general-purpose application and the recording operation, etc., by the exclusive application may be performed on one information recording/reproducing apparatus 300. Alternatively, only the recording operation, etc., by the general-purpose application may be performed on one information recording/reproducing apparatus 300. Alternatively, only the recording operation, etc., by the exclusive application may be performed on one information recording/reproducing apparatus 300.

(2) Recording Operation Example

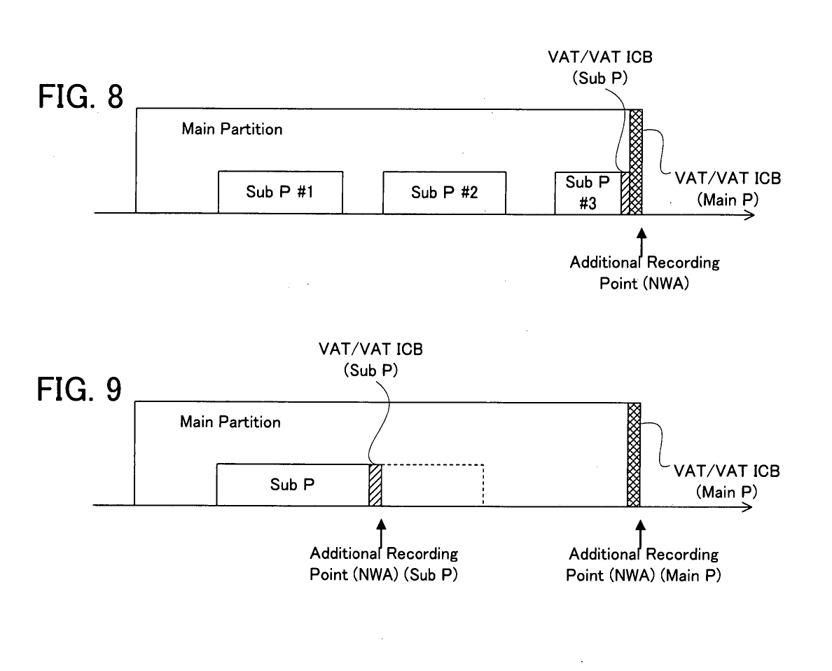

Next, with reference to FIG. 8 and FIG. 9, a recording operation by the information recording/reproducing apparatus in the embodiment will be explained. FIG. 8 and FIG. 9 conceptually show the file recorded in the sub partition during the recording operation.

If the optical disc 100 is loaded onto the information recording/reproducing apparatus 300 before the recording operation, it is selected whether a recording operation by the general-purpose application is performed or a recording operation by the exclusive application is performed, depending on the file to be recorded. This selection operation may be not performed if the information recording/reproducing apparatus only performs the recording operation in accordance with the general-purpose application or only performs the recording operation in accordance with the exclusive application. In the case of the recording operation by the general-purpose application, the file is recorded into the main partition 110. On the other hand, in the case of the recording operation by the exclusive application, the file is recorded into the sub partition 210 allocated from the beginning. Alternatively, one portion of the main partition 110 is allocated as the sub partition 210, and the file is recorded in the newly allocated sub partition 210.

Incidentally, as the aspect of the recording, two aspects which will be explained below can be considered, for example.

As shown in FIG. 8, in one aspect of the recording, the file is recorded from an additional recording point (NWA: Next Writable Address) which is common to each of the main partition 110 and the sub partition 210. Namely, there is only one additional recording point on the optical disc 100.

At this time, the file may be recorded so as to have the data structure using a Virtual Allocation Table (VAT) in accordance with the standard of the UDF. Specially, if the file is recorded onto the optical disc 100 of a DVD-R or the like wherein the file can be recorded only once, the VAT is preferably used. In using the VAT, a VAT_ICB for indicating an address position where the VAT is actually recorded is further recorded.

Moreover, as shown in FIG. 9, in the other aspect of the recording, the file is recorded into the main partition 110 from one additional recording point, and the file is recorded into the sub partition 210 from another additional recording point which is different from the one additional recording point. Namely, there are a plurality of additional recording points on the optical disc 100. For example, in the case that one sub partition can be a recording area to record therein a file used for the exclusive application and another sub partition can be a recording area to backup the file, it is possible to record the file (and its backup file) from recording point of each of the plurality of sub partitions. By this, it is possible to record the file (and its backup file) into the plurality of sub partitions simultaneously. At this time, the recording area following the VAT and the VAT_ICB is allocated in advance for the sub partition 210, and it is recognized to be a recorded recording area (i.e. used area) for the general-purpose application even if the file is not actually recorded.

The file can be recorded from any one of the plurality of additional recording points, so that it is possible to realize the more flexible recording operation.

Moreover, if the file is recorded in the whole recording area of the sub partition 210 which is allocated from the beginning, one portion of the recording area of the main partition 110 may be newly allocated as the sub partition 210. Alternatively, if the file is recorded onto the optical disc 100 that has only the main partition 110 from the beginning, every time the file is recorded by the exclusive application, the file may be recorded while one portion of the recording area of the main partition 110 is allocated as the sub partition 210.

(3) Reproduction Operation Example

Next, the reproduction operation (or execution operation) by the information recording/reproducing apparatus 300 in the embodiment will be explained.

If the optical disc 100 is loaded onto the information recording/reproducing apparatus 300 before the reproduction operation, it is selected whether a reproduction operation by the general-purpose application is performed or a reproduction operation by the exclusive application is performed, depending on the file to be reproduced. This selection operation may be not performed if the information recording/reproducing apparatus only performs the reproduction operation in accordance with the general-purpose application or only performs the reproduction operation in accordance with the exclusive application. In the case of the reproduction operation by the general-purpose application, the file recorded in the main partition 110 is reproduced or executed. On the other hand, in the case of the reproduction operation by the exclusive application, the file recorded in the sub partition 210 is reproduced or executed.

The recording operation and the reproduction operation are performed as explained above. Particularly, depending on the type of the applications (or the type of the files), the recording area to record or reproduce the file is changed. Thus, it is possible to receive the above-described various benefits owned by the above-described optical disc 100.

Moreover, in the embodiments, the optical disc 100 is explained as one example of the information recording medium, and the recorder or player associated with the optical disc 100 is explained as one example of the information recording/reproducing apparatus. The present invention, however, is not limited to the optical disc and the recorder thereof, and can be applied to other various high-density-recording or high-transmission-rate information recording media, and the recorders thereof.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2004-174729 filed on Jun. 11, 2004 including the specification, claims, drawings and summary is incorporated herein by reference in its entirety.

1. An information recording medium which complies with a predetermined file system, comprising:
a logical first recording area to record therein a first file which is recorded and reproduced by a first application; and
a logical second recording area to record therein a second file which is recorded and reproduced by a second application different from the first application.

2. The information recording medium according to claim 1, wherein said second recording area is located in said first recording area.

3. The information recording medium according to claim 1, wherein said second recording area is treated as a used area for the first application.

4. The information recording medium according to claim 1, wherein
the first application is a general-purpose application used for general recording and reproduction in the predetermined file system, and
the second application is an exclusive application used for a particular application in the predetermined file system.

5. The information recording medium according to claim 1, wherein
the first file is recorded only in said first recording area, and
the second file is recorded only in said second recording area.

6. The information recording medium according to claim 1, wherein
the first file is recorded into said first recording area so as to have a data structure that complies with the predetermined file system, and
the second file is recorded into said second recording area so as to have a data structure that complies with the predetermined file system.

7. The information recording medium according to claim 1, wherein
the first file is recorded into said first recording area so as to have a data structure that complies with the predetermined file system, and
the second file is recorded into said second recording area so as to have at least one portion of the data structure that complies with the predetermined file system.

8. The information recording medium according to claim 1, wherein management information which is used by the second application and which is to manage the second file is further recorded into said second recording area.

9. The information recording medium according to claim 8, wherein
said information recording medium comprises at least two second recording areas,
the second file is recorded into one second recording area out of said at least two second recording areas, and the management information is recorded in another second recording area which is different from the one second recording area.

10. The information recording medium according to claim 1, wherein allocation information for indicating at least one of allocation and a size of said second recording area with respect to a whole recording area of said information recording medium is further recorded into said second recording area.

11. The information recording medium according to claim 1, wherein pointer information for indicating a particular address position in said second recording area is further recorded into said first recording area.

12. The information recording medium according to claim 1, wherein pointer information for indicating a particular address position in said first recording area is further recorded into said second recording area.

13. The information recording medium according to claim 1, wherein attribute information for indicating at least one of an attribute of the second file, a transfer rate in recording or reproducing the second file, a minimum size of units which constitute the second file, and a seek rate of the second file is further recorded into said second recording area.

14. The information recording medium according to claim 1, wherein application information for specifying the second application is further recorded into said second recording area.

15. The information recording medium according to claim 1, wherein said second recording area is treated as a read-only recording area for the first application.

16. The information recording medium according to claim 1, wherein said information recording medium comprises a plurality of second recording areas.

17. The information recording medium according to claim 16, each of said plurality of second recording areas has an identification number for identifying the each second recording area.

18. An information recording apparatus for performing a recording operation with respect to an information recording medium which complies with a predetermined file system, comprising: a logical first recording area to record therein a first file which is recorded and reproduced by a first application; and a logical second recording area to record therein a second file which is recorded and reproduced by a second application different from the first application,
said information recording apparatus comprising:
a first recording device for recording the first file into said first recording area in accordance with the first application; and
a second recording device for recording the second file into said second recording area in accordance with the second application.

19. The information recording apparatus according to claim 18, further comprising a generating device for generating said second recording area by setting at least one portion of said first recording area to be a recording area to record therein the second file.

20. The information recording apparatus according to claim 18, wherein
allocation information for indicating at least one of allocation and a size of said second recording area with respect to a whole recording area of said information recording medium is recorded into said first recording area, and
said information recording apparatus further comprises a reconstructing device for reconstructing said second recording area, on the basis of the allocation information, if said second recording area is damaged.

21. An information recording apparatus for performing a recording operation with respect to an information recording medium which complies with a predetermined file system, comprising: a logical first recording area to record therein a first file which is recorded and reproduced by a first application; and a logical second recording area to record therein a second file which is recorded and reproduced by a second application different from the first application,
said information recording apparatus comprising:
a first recording device for recording the first file into said first recording area; and
a controlling device for controlling said first recording device to record the first file in accordance with the first application.

22. An information recording apparatus for performing a recording operation with respect to an information recording medium which complies with a predetermined file system, comprising: a logical first recording area to record therein a first file which is recorded and reproduced by a first application; and a logical second recording area to record therein a second file which is recorded and reproduced by a second application different from the first application,
said information recording apparatus comprising:
a second recording device for recording the second file into said second recording area; and
a controlling device for controlling said second recording device to record the second file in accordance with the second application.

23. An information recording method of performing a recording operation with respect to an information recording medium which complies with a predetermined file system, comprising: a logical first recording area to record therein a first file which is recorded and reproduced by a first application; and a logical second recording area to record therein a second file which is recorded and reproduced by a second application different from the first application,
said information recording method comprising:
a first recording process of recording the first file into said first recording area in accordance with the first application; and
a second recording process of recording the second file into said second recording area in accordance with the second application.

24. An information reproducing apparatus for performing a reproduction operation with respect to an information recording medium which complies with a predetermined file system, comprising: a logical first recording area to record therein a first file which is recorded and reproduced by a first application; and a logical second recording area to record therein a second file which is recorded and reproduced by a second application different from the first application,
said information reproducing apparatus comprising:
a first reproducing device for reading and reproducing the first file recorded in said first recording area in accordance with the first application; and
a second reproducing device for reading and reproducing the second file recorded in said second recording area in accordance with the second application.

25. The information reproducing apparatus according to claim 24, wherein
the first file is recorded in said first recording area so as to have a data structure that complies with the predetermined file system, the second file is recorded in said second recording area so as to have a data structure that complies with the predetermined file system, and
said first reproducing device reads the second file recorded in said second recording area.

26. An information reproducing apparatus for performing a reproduction operation with respect to an information recording medium which complies with a predetermined file system, comprising: a logical first recording area to record therein a first file which is recorded and reproduced by a first application; and a logical second recording area to record therein a second file which is recorded and reproduced by a second application different from the first application,
said information reproducing apparatus comprising:
a first reproducing device for reading and reproducing the first file recorded in said first recording area; and
a controlling device for controlling said first reproducing device to reproduce the first file in accordance with the first application.

27. An information reproducing apparatus for performing a reproduction operation with respect to an information recording medium which complies with a predetermined file system, comprising: a logical first recording area to record therein a first file which is recorded and reproduced by a first application; and a logical second recording area to record therein a second file which is recorded and reproduced by a second application different from the first application,
said information reproducing apparatus comprising:
a second reproducing device for reading and reproducing the second file recorded in said second recording area; and
a controlling device for controlling said second reproducing device to reproduce the second file in accordance with the second application.

28. An information reproducing method of performing a reproduction operation with respect to an information recording medium which complies with a predetermined file system, comprising: a logical first recording area to record therein a first file which is recorded and reproduced by a first application; and a logical second recording area to record therein a second file which is recorded and reproduced by a second application different from the first application,
said information reproducing method comprising:
a first reproducing process of reading and reproducing the first file recorded in said first recording area in accordance with the first application; and
a second reproducing process of reading and reproducing the second file recorded in said second recording area in accordance with the second application.

29. A computer program product in a computer-readable medium for tangibly embodying a program of instructions executable by a computer to make the computer function as at least one portion of a first recording device and a second recording device,
the computer being provided on an information recording apparatus for performing a recording operation with respect to an information recording medium which complies with a predetermined file system, comprising: a logical first recording area to record therein a first file which is recorded and reproduced by a first application; and a logical second recording area to record therein a second file which is recorded and reproduced by a second application different from the first application,
said information recording apparatus comprising:
said first recording device for recording the first file into said first recording area in accordance with the first application; and
said second recording device for recording the second file into said second recording area in accordance with the second application.

30. A computer program product in a computer-readable medium for tangibly embodying a program of instructions executable by a computer to make the computer function as at least one portion of a first recording device and a controlling device,
the computer being provided on an information recording apparatus for performing a recording operation with respect to an information recording medium which complies with a predetermined file system, comprising: a logical first recording area to record therein a first file which is recorded and reproduced by a first application; and a logical second recording area to record therein a second file which is recorded and reproduced by a second application different from the first application,
said information recording apparatus comprising:
said first recording device for recording the first file into said first recording area; and
said controlling device for controlling said first recording device to record the first file in accordance with the first application.

31. A computer program product in a computer-readable medium for tangibly embodying a program of instructions executable by a computer to make the computer function as at least one portion of a second recording device and a controlling device,
the computer being provided on an information recording apparatus for performing a recording operation with respect to an information recording medium which complies with a predetermined file system, comprising: a logical first recording area to record therein a first file which is recorded and reproduced by a first application; and a logical second recording area to record therein a second file which is recorded and reproduced by a second application different from the first application,
said information recording apparatus comprising:
said second recording device for recording the second file into said second recording area; and
said controlling device for controlling said second recording device to record the second file in accordance with the second application.

32. A computer program product in a computer-readable medium for tangibly embodying a program of instructions executable by a computer to make the computer function as at least one portion of a first reproducing device and a second reproducing device,
the computer being provided on an information reproducing apparatus for performing a reproduction operation with respect to an information recording medium which complies with a predetermined file system, comprising: a logical first recording area to record therein a first file which is recorded and reproduced by a first application; and a logical second recording area to record therein a second file which is recorded and reproduced by a second application different from the first application,
said information reproducing apparatus comprising:
said first reproducing device for reading and reproducing the first file recorded in said first recording area in accordance with the first application; and
said second reproducing device for reading and reproducing the second file recorded in said second recording area in accordance with the second application.

33. A computer program product in a computer-readable medium for tangibly embodying a program of instructions executable by a computer to make the computer function as at least one portion of a first reproducing device and a controlling device,
the computer being provided on an information reproducing apparatus for performing a reproduction operation with respect to an information recording medium which complies with a predetermined file system, comprising: a logical first recording area to record therein a first file which is recorded and reproduced by a first application; and a logical second recording area to record therein a second file which is recorded and reproduced by a second application different from the first application,
said information reproducing apparatus comprising:
said first reproducing device for reading and reproducing the first file recorded in said first recording area; and
said controlling device for controlling said first reproducing device to reproduce the first file in accordance with the first application.

34. A computer program product in a computer-readable medium for tangibly embodying a program of instructions executable by a computer to make the computer function as at least one portion of a second reproducing device and a controlling device,
the computer being provided on an information reproducing apparatus for performing a reproduction operation with respect to an information recording medium which complies with a predetermined file system, comprising: a logical first recording area to record therein a first file which is recorded and reproduced by a first application; and a logical second recording area to record therein a second file which is recorded and reproduced by a second application different from the first application,
said information reproducing apparatus comprising:
said second reproducing device for reading and reproducing the second file recorded in said second recording area; and
said controlling device for controlling said second reproducing device to reproduce the second file in accordance with the second application.

35. A data structure including a control signal which complies with a predetermined file system, comprising:
a logical first recording area to record therein a first file which is recorded and reproduced by a first application; and
a logical second recording area to record therein a second file which is recorded and reproduced by a second application different from the first application.
